(19) United States
(12) Patent Application Publication
(10) Pub. No.: US 2023/0075640 A1
(43) Pub. Date: Mar. 9, 2023

(54) Determination of Altitude Uncertainty Including Temperature Lapse Rate

(71) Applicant: NextNav, LLC, Sunnyvale, CA (US)

(72) Inventors: Michael DORMODY, San Jose, CA (US); Badrinath NAGARAJAN, South San Francisco, CA (US); Arun RAGHUPATHY, Ramagondanahalli (IN); Guiyuan HAN, San Jose, CA (US)

(73) Assignee: NextNav, LLC, Sunnyvale, CA (US)

(21) Appl. No.: 17/447,027

(22) Filed: Sep. 7, 2021

(51) Int. Cl. G01C 5/06; G01C 25/00

(52) U.S. Cl. CPC G01C 5/06; G01C 25/00

(57) ABSTRACT

A calculated current lapse rate is determined for a geographical area that includes a location of a mobile device. The calculated current lapse rate provides an estimated air temperature variation with respect to altitude variation for the location of the mobile device. An altitude of the mobile device is estimated. An uncertainty of the altitude of the mobile device is estimated based on a reference pressure and a reference temperature for a reference plane that is within the geographical area, a device pressure for the mobile device, and the calculated current lapse rate.

### BACKGROUND

Some mobile devices are part of systems that determine altitude of the mobile devices based on barometric pressure. In a barometric-based location determination system, altitude of the mobile device is estimated using a barometric formula that takes into account measurements from a barometric pressure sensor in the mobile device and pressure and temperature measurements obtained from a calibrated network of sensors deployed at known locations and altitudes near the mobile device.

In addition to estimating the altitude of the mobile device, the systems also typically estimate the potential error, confidence, or uncertainty of the altitude estimation. Each of the measured parameters that go into the barometric formula for the calculation of the altitude typically has an associated uncertainty with which the uncertainty of the resulting altitude estimation can be determined. Different applications or situations may call for different levels of accuracy in both the altitude estimation and the uncertainty estimation.

### SUMMARY

This disclosure describes an improved system and method for determination of uncertainty in the altitude of a mobile device that takes into account the air temperature lapse rate at the location or general area of the mobile device. In some embodiments, a method, by a server, includes: estimating a location of a mobile device; receiving a device pressure from the mobile device; determining a calculated current lapse rate for a geographical area that includes the location of the mobile device, the calculated current lapse rate providing an estimated air temperature variation with respect to altitude variation for the location of the mobile device; receiving a reference pressure and a reference temperature for a reference plane that is within the geographical area; estimating an altitude of the mobile device; and estimating an uncertainty of the altitude of the mobile device based on the reference pressure, the reference temperature, the device pressure, and the calculated current lapse rate.

In some embodiments, the estimating of the uncertainty of the altitude of the mobile device is further based on an uncertainty of the reference temperature, an uncertainty of the reference pressure, and an uncertainty of the device pressure. In some embodiments, the calculated current lapse rate is updated a plurality of times per day. In some embodiments, the determining of the calculated current lapse rate further comprises estimating the calculated current lapse rate when the server determines that the altitude of the mobile device and the uncertainty of the altitude are to be estimated. In some embodiments, the determining of the calculated current lapse rate further includes: receiving a plurality of temperature measurements and a plurality of sensor altitudes for a respective plurality of sensors that are within the geographical area; for each pair of sensors of the plurality of sensors that are not at about a same altitude, determining a temperature difference between the temperature measurements therefor with respect to an altitude difference between the sensor altitudes therefor to obtain a plurality of temperature-difference to altitude-difference ratios; determining a mean of the plurality of temperature-difference to altitude-difference ratios; and using the mean of the plurality of temperature-difference to altitude-difference ratios as the calculated current lapse rate for the geographical area. In some embodiments, the determining of the calculated current lapse rate further includes: receiving a plurality of temperature measurements and a plurality of sensor altitudes for a respective plurality of sensors that are within the geographical area; for each pair of sensors of the plurality of sensors that are not at about a same altitude, determining a temperature difference between the temperature measurements therefor with respect to an altitude difference between the sensor altitudes therefor to obtain a plurality of temperature-difference to altitude-difference ratios; determining a grid of lapse rate data based on the plurality of temperature-difference to altitude-difference ratios; and interpolating the calculated current lapse rate from the grid of lapse rate data. In some embodiments, a reference altitude is received for the reference plane; the server determines whether a difference between the estimated altitude of the mobile device and the reference altitude for the reference plane is greater than a threshold distance; when the difference between the estimated altitude of the mobile device and the reference altitude for the reference plane is greater than the threshold distance, the calculated current lapse rate is used in the estimating of the uncertainty of the altitude of the mobile device; and when the difference between the estimated altitude of the mobile device and the reference altitude for the reference plane is not greater than the threshold distance, the server does not determine the calculated current lapse rate, and the server estimates the uncertainty of the altitude of the mobile device without using the calculated current lapse rate. In some embodiments, a reference altitude is received for the reference plane; and the estimated altitude of the mobile device is based on the reference altitude, the reference pressure, the reference temperature, the device pressure, and the calculated current lapse rate. In some embodiments, one or more non-transitory machine-readable media embodying program instructions that, when executed by one or more machines, cause the one or more machines to implement the method described above. In some embodiments, a system includes: memory comprising computer-executable instructions; and a machine configured to execute the computer-executable instructions and cause the system to perform the method of claim 1. In some embodiments, the mobile device performs some of the functions described above.

### BRIEF DESCRIPTION OF THE DRAWINGS

FIG. 1 is a simplified schematic diagram of an example system for estimating an altitude and an uncertainty of the altitude of a mobile device, in accordance with some embodiments.

FIG. 2 is a simplified example environment in which a mobile device can be used, and the altitude and the uncertainty of the altitude can be estimated, in accordance with some embodiments.

FIG. 3 is an example graph of a temperature lapse rate vs date, in accordance with some embodiments.

FIG. 4 is a simplified flowchart for an example process for estimating the lapse rate within a geographical area, in accordance with some embodiments.

FIG. 5 shows example graphs of a difference between using and not using the lapse rate in determining altitude vs the vertical distance between a reference device and a mobile device, in accordance with some embodiments.

FIG. 6 is a simplified flowchart for an example process for determining fit terms for use in a formula for estimating the uncertainty of an altitude estimation, in accordance with some embodiments.

FIG. 7 is a simplified flowchart for an example process for estimating altitude uncertainty using the lapse rate, in accordance with some embodiments.

FIG. 8 shows simplified schematic diagrams of a transmitter, a mobile device, and a server, in accordance with some embodiments.

### DETAILED DESCRIPTION

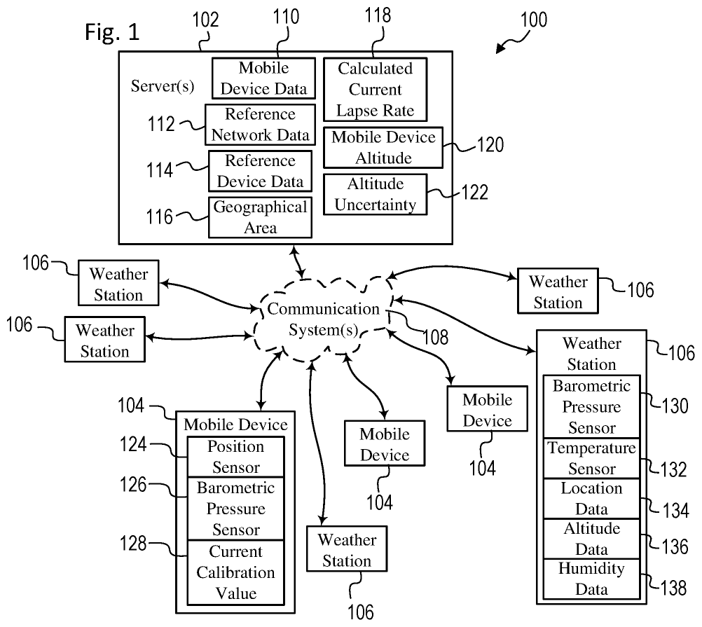

FIG. 1 shows a system 100 that estimates the altitude of a mobile device and provides an improved estimation of the error, uncertainty, confidence, or quality in the altitude estimation, in accordance with some embodiments. The system 100 generally includes one or more servers 102, one or more mobile devices 104, and a reference network of weather stations 106 (i.e., reference sensors) that communicate together through one or more communication systems 108. Using location data from one of the mobile devices 104, the server 102 estimates the location of the mobile device 104. With the location of the mobile device 104, the server 102 determines a geographical area that includes the location of the mobile device 104 and a selection of the weather stations 106. The server 102 estimates a calculated current lapse rate for the geographical area (or for the location of the mobile device 104) using pressure, temperature and altitude data for the selected weather stations 106. The calculated current lapse rate provides an estimated air temperature variation with respect to altitude variation for the location of the mobile device 104. The server 102 estimates the altitude of the mobile device 104 using (at least) pressure data from the mobile device 104 and pressure, temperature, and altitude data for a reference plane or location near the mobile device 104 (e.g., data from one of the weather stations 106 that is nearest the mobile device 104, an averaged pressure and temperature from multiple weather stations in the vicinity of the mobile device 104, an interpolated pressure and temperature based on a model of the pressure and temperature determined from measurements from the reference network of weather stations 106, or a reference pressure and temperature based on other methods). The server 102 estimates the uncertainty in the altitude estimation using (at least) the calculated current lapse rate, the pressure data from the mobile device 104, and the pressure and temperature data for the reference plane or location near the mobile device 104. Consequently, the system 100 enables a technique for estimating the uncertainty for a barometric-based altitude measurement using the more general barometric formula (described below) that includes the calculated current lapse rate, compared to a simplified version of the barometric formula that does not take the lapse rate into account. This technique results in a more accurate or reliable or higher quality characterization of the altitude uncertainty in a variety of situations in which the lapse rate could be a significant factor, for example, when the mobile device 104 is far above or below the reference plane or location (e.g., for a drone (UAV), air taxi, etc.), when the lapse rate is non-zero or non-typical and/or changes across time, or when there is a significant outside ambient temperature difference between the mobile device 104 and the reference plane or location for which the reference pressure and reference temperature are determined, among other situations.

The server 102 generally represents one or more computerized devices, such as a cloud computing system, a server farm, a set of computers, a desktop computer, a notebook computer, among others. In some embodiments, the server 102 generally contains mobile device data 110, reference network data 112, reference device data 114, a geographical area 116, a calculated current lapse rate 118, a mobile device altitude 120, and an altitude uncertainty value 122, among other hardware, software and data. The mobile device data 110 generally represents data received from one of the mobile devices 104, such as location data and pressure data, among other data. The server 102 generally maintains such mobile device data 110 for each of the mobile devices 104 for which the server 102 provides altitude estimation services. The reference network data 112 generally represents data received from or maintained for each of weather stations 106 in the reference network of weather stations 106, such as location data, altitude data, pressure data and temperature data, among other data.

In some embodiments, for each mobile device 104, with the location data therefor, the server 102 determines an appropriate region for the geographical area 116 surrounding that location. With the geographical area 116, the server 102 selects the weather stations 106 within the geographical area 116 and uses the reference network data 112 for the selected weather stations 106 to estimate the calculated current lapse rate 118 for the geographical area 116 (or the location of the mobile device 104) when needed for the altitude and uncertainty estimations. In this manner, the server 102 can estimate the geographical area 116 and the calculated current lapse rate 118 that is currently relevant or related to each mobile device 104 at any given time, e.g., when the server determines that the altitude of the mobile device and the uncertainty of the altitude are to be estimated. Alternatively, the server 102 can subdivide a larger region into multiple geographical areas 116 (which may overlap) and maintain the calculated current lapse rate 118 for each one of the multiple geographical areas 116. The server 102 periodically updates each calculated current lapse rate 118, so that the calculated current lapse rate 118 for each one of the multiple geographical areas 116 is relatively current. Then the server 102 selects the calculated current lapse rate 118 for the geographical area 116 that is most appropriate to the location of each mobile device 104 when needed.

In some embodiments, for each mobile device 104, the server 102 selects a reference plane or location near the mobile device 104 (e.g., based on one or more of the weather stations 106 in the reference network of weather stations 106 or the selected weather stations 106). For each mobile device 104, therefore, the reference device data 114 generally represents data determined for the reference plane or location. With the mobile device data 110 and the reference device data 114 (and optionally the calculated current lapse rate 118), the server 102 estimates the mobile device altitude 120 for the mobile device 104. With the mobile device data 110, the reference device data 114, and the calculated current lapse rate 118, the server 102 also estimates the altitude uncertainty value 122 associated with the mobile device altitude 120, as described below. The server 102 transmits the mobile device altitude 120 and the altitude uncertainty value 122 to the mobile device 104.

The mobile devices 104 each generally represent a smart phone, a cell phone, a personal computer, a wearable computing device, etc. or hardware (and associated software) installed in an aircraft, a drone aircraft, a vehicle, etc. In some embodiments, each mobile device 104 generally includes a position sensor 124, a barometric pressure sensor 126, and a current calibration value 128, among other hardware, software and data. The position sensor 124 generally represents one or more appropriate sensor devices and associated software for detecting a position of the mobile device 104, such as for a Global Navigation Satellite System (GNSS, such as GPS, GLONASS, Galileo, Compass/Beidou), a terrestrial transmitter system, or a hybrid satellite/terrestrial system, among others. The barometric pressure sensor 126 represents any appropriate sensor device that generates an atmospheric pressure measurement with which the server 102 or the mobile device 104 determines its altitude and uncertainty therefor. The current calibration value 128 is used by the mobile device 104 or the barometric pressure sensor 126 to calibrate the barometric pressure sensor 126, i.e., to adjust the raw pressure measurement to obtain a more accurate adjusted pressure measurement with which to determine the altitude.

In some embodiments, the mobile device 104 performs some of the functions described herein as being performed by the server 102. Therefore, either the mobile device 104 or the server 102 receives the mobile device data 110, the reference network data 112, and/or the reference device data 114. Then either the mobile device 104 or the server 102 determines or estimates the geographical area 116, the calculated current lapse rate 118, the mobile device altitude 120, and/or the altitude uncertainty value 122.

The reference network of weather stations 106 generally represents any appropriate hardware (and associated software) for atmospheric sensors that collect data of atmospheric pressure, air temperature and moisture at each weather station 106. Thus, each weather station 106 generally includes a barometric pressure sensor 130, a temperature sensor 132, location data 134, altitude data 136, and humidity data 138, among other hardware, software and data. The pressure data from the barometric pressure sensor 130, the temperature data from the temperature sensor 132, location data 134, and the altitude data 136 generally form the reference network data 112 for the reference network of weather stations 106 (or for the selected weather stations 106 for the geographical area 116) and/or are used to determine the reference device data 114.

The weather stations 106, while being distributed spatially horizontally across a region, are also vertically characterized by a diversity of installation heights or altitudes. The installation height diversity allows for the estimation of the calculated current lapse rate 118 using the reference network data 112 from the reference network of weather stations 106. The calculated current lapse rate 118 may be used in the computation of the altitude using the general barometric equation, described below, and allows for a relatively accurate estimation of altitude confidence or uncertainty by capturing the temporal and spatial variability of the calculated current lapse rate 118.

The communication systems 108 generally represent any appropriate combination of the Internet, cell phone communication systems, broadband cellular networks, wide area networks (WANs), local area networks (LANs), wireless networks, networks based on the IEEE 802.11 family of standards (Wi-Fi networks), direct radio communication, and other data communication systems or networks. Thus, the other components (102, 104 and 106) can communicate with each other as needed through any combination of these types of communication systems or networks.

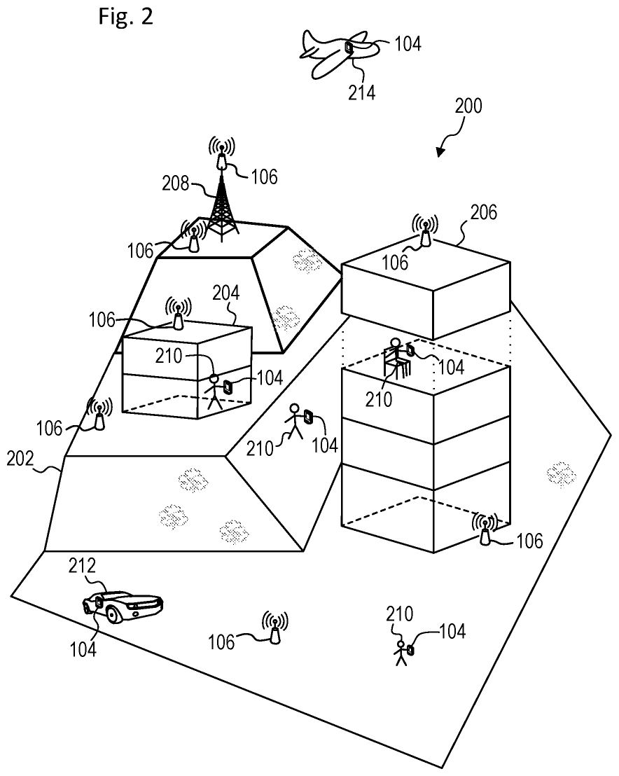

FIG. 2 shows a simplified example environment 200 in which the mobile device 104 can be used, and the altitude and the uncertainty of the altitude can be estimated, in accordance with some embodiments. As an example, the environment 200 covers the geographical area 116 for the mobile devices 104 shown. Therefore, the environment 200 includes an example set of the selected weather stations 106 (for the geographical area 116) and examples of the mobile devices 104. Also, the example environment 200 includes a terrain 202 having ground levels at different elevations (altitudes) and structures, such as buildings 204 and 206 having floor levels at different altitudes and a transmission tower 208.

The weather stations 106 form a network of terrestrial transmitters that may be located at different altitudes or depths that are inside or outside various natural or manmade structures (e.g., buildings 204 and 206 and transmission tower 208), relative to different altitudes throughout the terrain 202, as illustrated by the examples in FIG. 2. In some embodiments, sensor measurements and positioning signals are transmitted from the weather stations 106 and subsequently received by the mobile device 104 and/or the server 102 using known transmission technologies. Positioning signals may also be transmitted from transmitters (that are not weather stations, e.g., the transmission tower 208) located throughout the example environment 200 or from satellites high above the example environment 200. For example, the sensor measurements and positioning signals may be transmitted using one or more common multiplexing parameters that utilize time slots, pseudorandom sequences, frequency offsets, or other approaches, as is known in the art or otherwise disclosed herein.

The mobile devices 104 may be carried by users 210 located at different altitudes or depths that are inside or outside various natural or manmade structures (e.g., buildings 204 and 206), relative to different altitudes throughout the terrain 202, as illustrated by the examples in FIG. 2. The mobile devices 104 may also be carried or mounted in a vehicle 212 within the environment 200 or an aircraft 214 high above the environment 200.

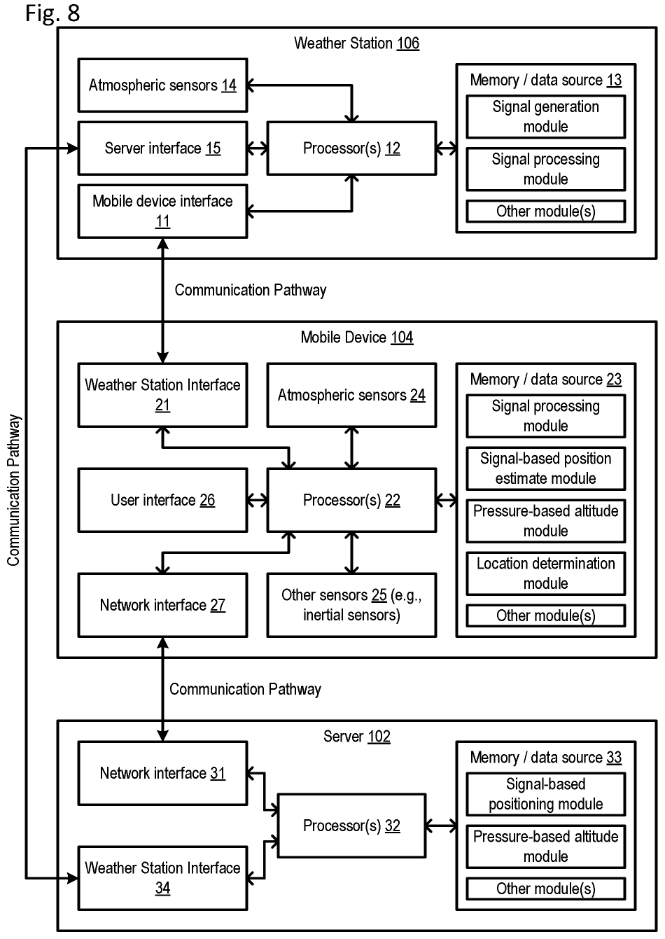

Examples of possible hardware, software and data components in the weather stations 106, the mobile device 104, and the server 102 are shown in FIGS. 1 and 8, as described herein. In particular, each weather station 106 and mobile device 104 may include appropriate atmospheric sensors (e.g., the barometric pressure sensors 126 and 130 and the temperature sensor 132) for generating measurements of atmospheric conditions (e.g., atmospheric pressure and temperature) that are used to estimate the altitude of the mobile device 104, to estimate the uncertainty in the altitude estimation, or to calibrate the barometric pressure sensor 126 therein.

The formula to translate pressure from one elevation to another elevation (at locations near each other) is known in the literature as the barometric equation:

$${P}_{1} = {{P}_{0} ( \frac{T + L \times ( {h}_{1} - {h}_{0} )}{T} )}^{\frac{- gM}{RL}} \qquad Equation 1$$

where P₀ is the pressure measured at a first elevation in units Pa, P₁ is the pressure to be calculated at a second elevation in units Pa, h₀ is the altitude of the first elevation, h₁ is the altitude of the second elevation, T is the measured ambient temperature at the first elevation in degree K, L is the atmospheric lapse rate in the area surrounding the two locations in degree K and quantifies how much the ambient air temperature changes with altitude, M is the molar mass of dry air (often approximately 0.0289 kg/mol), g is the gravitational acceleration constant of Earth (approximately 9.8 m/s²), R is the universal gas constant (approximately 8.31 J/(mol K)), and the negative/positive sign on

$$\frac{gM}{R L}$$

depends on whether g is treated as positive or negative. Using the formula of Equation 1, a reference pressure can be translated from one reference plane to any other reference plane and back again, depending on requirements of the situation.

To translate from a reference pressure of the reference plane or location or measured by the reference barometric pressure sensor 130 of one of the weather stations 106 to a calculated pressure for one of the mobile devices 104 (that is relatively near the weather station 106), the variables in Equation 1 are relabeled accordingly:

$${P}_{device} = {{P}_{ref} ( \frac{T + L \times ( {h}_{device} - {h}_{ref} )}{T} )}^{\frac{- gM}{R L}} \qquad Equation 2$$

where P_{ref} is the reference pressure of the reference plane or location or measured by the reference barometric pressure sensor 130 of the weather station 106, h_{ref} is the altitude of the weather station 106, h_{device} is the altitude of the mobile device 104, and P_{device} is the calculated pressure at the mobile device 104. Alternatively, P_{ref} can be the pressure of the reference barometric pressure sensor 130 at a height different from its altitude, for example 0 m HAE (Height Above Ellipsoid) or 0 m Mean Sea Level (MSL), and h_{ref} would be 0 m HAE or 0 m MSL, respectively.

In some conventional systems, the lapse rate L is fixed to −6.5 degrees K (or C.) per km for altitudes less than 10 km above sea level (called the troposphere). In other conventional systems, the lapse rate L is assumed to be zero, which simplifies the formula. However, the lapse rate L can vary significantly based on time of day, prevailing weather conditions, and regional differences. In fact, lapse rates at some locations are observed to vary across different times from −15 degrees K per km to 12 degrees K per km (or more). A positive lapse rate L is referred to as an inversion and characterizes colder layers occurring beneath warmer air layers.

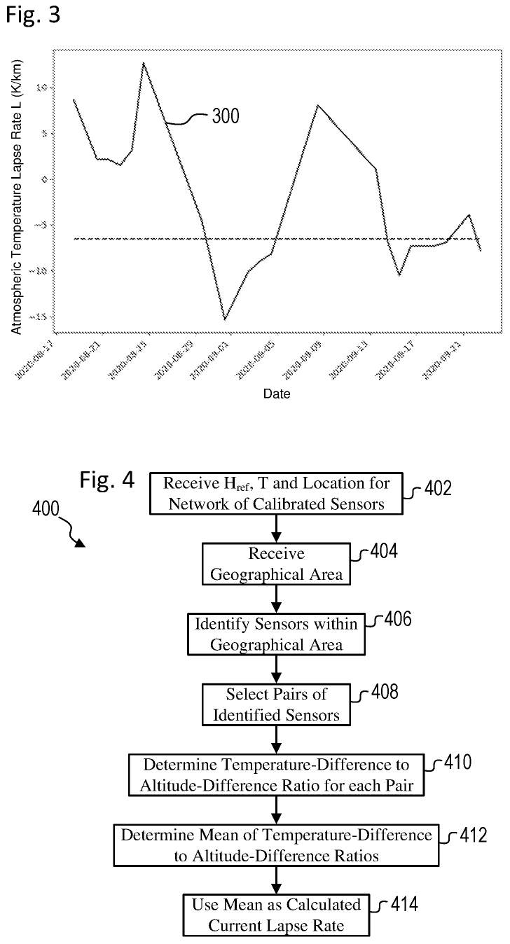

FIG. 3 illustrates an example graph 300 of a measured atmospheric temperature lapse rate L vs date for an example of the geographical area 116. The typical lapse rate of −6.5 K/km is shown as a horizontal dashed line. As can be seen, over a period of about 34 days, the lapse rate L varied significantly above and below the typical lapse rate between about −15 K/km to 12 K/km.

FIG. 4 shows a simplified flowchart for an example process 400 for estimating the lapse rate within a geographical area, in accordance with some embodiments. A relatively accurate lapse rate L (such as for the example graph 300 for an example of the geographical area 116) can be determined from this process 400 by using a reference weather network (e.g., the weather stations 106) owing to the diversity in the vertical separation of the sites for each weather station in the network. The particular steps, combination of steps, and order of the steps for the process 400 are provided for illustrative purposes only. Other processes with different steps, combinations of steps, or orders of steps can also be used to achieve the same or similar result. Features or functions described for one of the steps performed by one of the components may be enabled in a different step or component in some embodiments. Additionally, some steps may be performed before, after or overlapping other steps, in spite of the illustrated order of the steps. Furthermore, although the example process 400 is described as being performed by the server 102, it is understood that in some embodiments some or all of the steps of the process 400 can be performed by the mobile device 104, instead, when the mobile device 104 generates or receives the necessary data.

At 402, the server 102 receives the measured reference altitudes h_{ref}, measured reference temperatures T, and locations for a network of calibrated sensors, e.g., the pressure and temperature sensors for the weather stations 106. Additionally, at 404, the server 102 receives an indication of the geographical area 116 surrounding the location of the mobile device 104. Thus, at 406, the server 102 identifies the sensors for the selected weather stations 106 within the geographical area 116.

At 408, the server 102 selects pairs of the identified sensors that are not at the same altitude. At 410, the server 102 determines a temperature difference between the temperature measurements therefor with respect to an altitude difference between the sensor altitudes (i.e., a plurality of temperature-difference to altitude-difference ratios) for each pair of sensors using the reference altitudes h_{ref} (sensor altitudes) and reference temperatures T (temperature measurements) for the identified sensors within the geographical area 116. For example, if there are n weather stations 106 at altitudes of h₁ h₂, . . . , hₙ with sensors measuring temperatures T₁, T₂, . . . , Tₙ, then the lapse rate is determined by using data from each pair of sensors (from weather stations 106 that are not at the same altitude) according to:

$$\frac{{dT}_{k}}{{dz}_{k}} = \frac{{T}_{k} - {T}_{k - 1}}{{h}_{k} - {h}_{k - 1}} \qquad Equation 3$$

where k varies from 1 to n, dTₖ is the temperature difference for the pair of sensors of the weather stations 106, and dzₖ is the altitude difference for the pair of weather stations 106.

At 412, the server 102 determines the mean of the temperature-difference to altitude-difference ratios, i.e.,:

$$L = \frac{{dT}_{a u}}{dz} = ( \frac{1}{n} ) [ \frac{{dT}_{1}}{{dz}_{1}} + \frac{{dT}_{2}}{{dz}_{2}} + … + \frac{{dT}_{n}}{{dz}_{n}} ] . \qquad Equation 4$$

At 414, the server 102 uses the mean of the temperature-difference to altitude-difference ratios for all pairs of the weather stations 106 as the calculated current lapse rate L for the geographical area 116. As an alternative to 412 and 414, the data for the temperature-difference to altitude-difference ratios for all pairs of the weather stations 106 can be formed into a grid of lapse rate data across the geographical area 116, and the calculated current lapse rate L for the location of the mobile device 104 can be interpolated from this grid of data.

Solving Equation 2 for the difference between the altitude of the mobile device 104 and the reference altitude (h_{device}−h_{ref}) in terms of the other variables results in:

$${h}_{device} - {h}_{ref} = \frac{- T}{L} [ 1 - {( \frac{{P}_{device}}{{P}_{ref}} )}^{\frac{- R L}{gM}} ] \qquad Equation 5$$

where h_{ref} is 0 m HAE (height above ellipsoid), the reference altitude of one of the weather stations 106 used as a reference sensor, the average terrain of the geographical area 116, or any other appropriate altitude; P_{ref} is the measured reference pressure at the reference-sensor weather station 106 translated to the reference altitude h_{ref}; and P_{device} is the measured device pressure at the mobile device 104.

Equation 5 can be simplified when the lapse rate L is negligible (i.e., the limit of the equation as L approaches 0), resulting in:

$${h}_{device} - {h}_{ref} = \frac{R T}{gM} ln ( \frac{{P}_{ref}}{{P}_{device}} ) . \qquad Equation 6$$

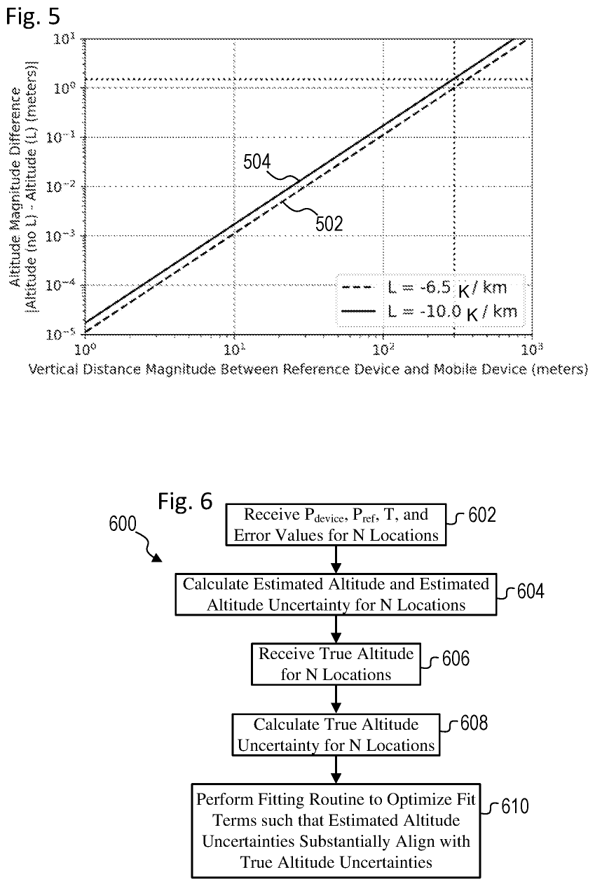

The difference between the general formula of Equation 5 (using the lapse rate L) and the simplified formula of Equation 6 (not using the lapse rate L) for a selection of two different lapse rates L at the same temperature T=20 C is illustrated by FIG. 5. Graphs 502 and 504 show the magnitude (i.e., absolute value) difference between altitude calculated using the simplified lapse-rate-free barometric formula of Equation 6 and altitude calculated using the full lapse-rate-based barometric formula of Equation 5 for two different lapse rate values as a function of the vertical distance magnitude between the reference device (i.e., one of the weather stations 106, the average height of all weather stations in the vicinity, or the reference plane or location) and the mobile device 104. Dashed line graph 502 uses a lapse rate L of −6.5 K/km and a measured temperature T of 20 C; and solid line graph 504 uses a lapse rate L of −10.0 K/km and a measured temperature T of 20 C. For example, when the vertical distance magnitude between the reference weather station 106 and the mobile device 104 is only about 1 m (10⁰ m), the difference in the results between Equation 6 and Equation 5 is negligible. At about 10 m (10¹ m) vertical distance magnitude, the difference between the results of the two equations is about 1 mm (10⁻³ m) for graph 502 and about 2 mm for graph 504. At about 100 m (10² m) vertical distance magnitude, the difference between the results of the two equations is about 0.1 m (10⁻¹ m) for graph 502 and about 0.2 m for graph 504. At about 300 m vertical distance magnitude (vertical dashed line), the difference between the results of the two equations is about 1 m (10⁰ m) for graph 502 and almost 1.5 m (horizontal dashed line) for graph 504. As the vertical distance magnitude approaches 1 km (10³ m), the difference between the results of the two equations exceeds 10 m (10¹ m) for both graphs 502 and 504.

As shown by the graphs 502 and 504, as the vertical distance magnitude between the reference weather station 106 and the mobile device 104 increases, the difference between the results of Equation 6 and Equation 5 becomes more significant. Additionally, a larger magnitude lapse rate L results in a larger, more significant difference between the results of the two barometric formula equations. Therefore, the need to use the full barometric formula of Equation 5 instead of the simplified barometric formula of Equation 6 generally depends on the altitude sensitivity requirements of the application using these formulas, the amount of the vertical difference between the reference weather station 106 (or reference plane) and the mobile device 104, and the amount of the magnitude of the lapse rate L. For example, if there is a relatively small vertical difference between the reference weather station 106 (or the reference plane altitude) and the mobile device 104 (e.g., less than about 100 m), a relatively small magnitude lapse rate L, and/or a lesser, looser level of altitude sensitivity of the application using these formulas, then the simplified lapse-rate-free barometric formula of Equation 6 can potentially be sufficient, which can potentially save on computer processing and memory usage and/or network usage. However, if there is a relatively large vertical difference between the reference weather station 106 (or reference plane) and the mobile device 104 (e.g., several multiples of 100 m), a relatively large magnitude lapse rate L, and/or a greater, tighter level of altitude sensitivity of the application using these formulas, then it can be preferable to use the full barometric formula of Equation 5 due to its increased accuracy.

Whether the altitude is determined by the full general formula of Equation 5 or the simplified formula of Equation 6, an improved result for the uncertainty can be quantified by propagating the uncertainty associated with each of the variables in the barometric formula and allowing for some additional fit terms to help align the expected result with data measured in the field. To begin with, if the error according to the three variables T, P_{device}, and P_{ref} is propagated in the full general formula of Equation 5 using known techniques of error propagation and assuming that these variables are independent and uncorrelated, then the uncertainty formula is:

$${σ}_{h}^{2} = {( 1 - {( \frac{{P}_{device}}{{P}_{ref}} )}^{\frac{- R L}{gM}} )}^{2} {( \frac{1}{L} )}^{2} {σ}_{T}^{2} + {( \frac{R T}{gM} )}^{2} {( \frac{{P}_{device}}{{P}_{ref}} )}^{\frac{- 2 R L}{gM}} {( \frac{{σ}_{{P}_{ref}}}{{P}_{ref}} )}^{2} + {( \frac{R T}{gM} )}^{2} {( \frac{{P}_{device}}{{P}_{ref}} )}^{\frac{- 2 R L}{gM}} {( \frac{{σ}_{{P}_{device}}}{{P}_{device}} )}^{2} \qquad Equation 7$$

where σₕ is the estimation of the uncertainty of the altitude estimation, σ_{T} is the uncertainty in the measurement of the reference temperature T, σ_{P}_{_{ref}} is the uncertainty in the measurement of the reference pressure P_{ref}, σ_{P}_{_{device}} is the uncertainty in the measurement of the device pressure P_{device}, and other variables are defined above.

Equation 7 can be simplified to:

$${σ}_{h}^{2} = {( 1 - {( \frac{{P}_{device}}{{P}_{ref}} )}^{- K L} )}^{2} {( \frac{1}{L} )}^{2} {σ}_{T}^{2} + {( KT )}^{2} {( \frac{{P}_{device}}{{P}_{ref}} )}^{- 2 K L} [ {( \frac{{σ}_{{P}_{ref}}}{{P}_{ref}} )}^{2} + {( \frac{{σ}_{{P}_{device}}}{{P}_{device}} )}^{2} ] \qquad Equation 8$$

where K is R/gM (i.e., approximately 30 m/K).

For the simplified case in which the lapse rate L is assumed to be negligible or very small (i.e., the limit of σₕ as L approaches 0), the formula simplifies to:

$${lim}_{L \to 0} {σ}_{h}^{2} \to {{K}^{2} [ ln ( \frac{{P}_{device}}{{P}_{ref}} ) ]}^{2} {σ}_{T}^{2} + {( K T )}^{2} [ {( \frac{{σ}_{{P}_{ref}}}{{P}_{ref}} )}^{2} + {( \frac{{σ}_{{P}_{device}}}{{P}_{device}} )}^{2} ] . \qquad Equation 9$$

For the general formula of Equation 8, however, the estimation of the uncertainty of the altitude estimation (σₕ) is determined by taking the square root of both sides of the equation to obtain the lapse-rate-based barometric formula:

$${σ}_{h} = \sqrt{\begin{matrix}{( 1 - {( \frac{{P}_{device}}{{P}_{ref}} )}^{- K L} )}^{2} {( \frac{1}{L} )}^{2} {σ}_{T}^{2} + \\ {( KT )}^{2} {( \frac{{P}_{device}}{{P}_{ref}} )}^{- 2 K L} [ {( \frac{{σ}_{{P}_{ref}}}{{P}_{ref}} )}^{2} + {( \frac{{σ}_{{P}_{device}}}{{P}_{device}} )}^{2} ]\end{matrix}} . \qquad Equation 10$$

To align the theoretical altitude uncertainty estimation of Equation 10 with actual observed altitude uncertainty, a systematic uncertainty term σ_{systematic} is added and fit terms (coefficients) A, B, C, D, and E are applied to each uncertainty term and to the equation as a whole to obtain a modified lapse-rate-based barometric formula:

$${σ}_{h} = \sqrt{\begin{matrix}A {( 1 - {( \frac{{P}_{device}}{{P}_{ref}} )}^{- K L} )}^{2} {( \frac{1}{L} )}^{2} {σ}_{T}^{2} + \\ {( KT )}^{2} {( \frac{{P}_{device}}{{P}_{ref}} )}^{- 2 K L} [ {B ( \frac{{σ}_{{P}_{ref}}}{{P}_{ref}} )}^{2} + {C ( \frac{{σ}_{{P}_{device}}}{{P}_{device}} )}^{2} ] + \\ D {σ}_{systematic}^{2}\end{matrix}} + E \qquad Equation 11$$

where fit term A is used to adjust the term in the formula for the reference temperature measurement uncertainty σ_{T}, fit term B is used to adjust the term in the formula for the reference pressure measurement uncertainty σ_{P}_{_{ref}}, fit term C is used to adjust the term in the formula for the device pressure measurement uncertainty σ_{P}_{_{device}}, fit term D is used to adjust the systematic uncertainty term σ_{systematic}, and fit term E is a general catch-all for aligning the formula as a whole.

The systematic uncertainty term σ_{systematic} is used to take into consideration any overall systematic error in the measured values that might occur for a given location or time of day. By comparing the calculated altitude uncertainty with an observed uncertainty for different locations (e.g., different cities or metropolitan areas) and different times of day and observing an apparently repeatable overall difference between the calculated and observed values, the systematic uncertainty term σ_{systematic} can be determined for these locations and times.

The fit terms A, B, C, D, and E are used to “tune” each of the terms of the formula for estimating the uncertainty of the altitude estimation, as well as the formula as a whole. FIG. 6 shows a simplified flowchart for an example process 600 for determining the fit terms A, B, C, D, and E, in accordance with some embodiments. The particular steps, combination of steps, and order of the steps for the process 600 are provided for illustrative purposes only. Other processes with different steps, combinations of steps, or orders of steps can also be used to achieve the same or similar result. Features or functions described for one of the steps performed by one of the components may be enabled in a different step or component in some embodiments. Additionally, some steps may be performed before, after or overlapping other steps, in spite of the illustrated order of the steps. Furthermore, although the example process 600 is described as being performed by the server 102, it is understood that in some embodiments some or all of the steps of the process 600 can be performed by the mobile device 104, instead, when the mobile device 104 generates or receives the necessary data.

At 602, the server 102 receives the data for the formula for estimating altitude uncertainty, i.e., the device pressure P_{device}, the reference pressure P_{ref}, the reference temperature T, the associated error values (σ_{P}_{_{device}}, σ_{P}_{_{ref}}, and σ_{T}), and the systematic error value σ_{systematic} for N locations for the mobile device 104 (i.e., a large number of diverse locations and times of day). At 604, the server 102 calculates the estimated altitude and the estimated altitude uncertainty for the N locations.

At 606, the server 102 receives the true altitude for the N locations. At 608, the server 102 calculates the actual observed/measured/true altitude uncertainty for the N locations based on the true altitudes and estimated altitudes. At 610, the server 102 adjusts the fit terms by performing a fitting routine to optimize the values of the fit terms A, B, C, D, and E, such that the estimated altitude uncertainties more closely align with the measured true altitude uncertainties for the N locations. In this manner, the altitude uncertainty measurement σₕ is in effect “calibrated” on real field data by fitting for A, B, C, D and E. Additionally, the server 102 periodically updates the fit terms A, B, C, D, and E as new data is acquired, so that the most recent values for the fit terms A, B, C, D, and E can be used when the server 102 performs a calculation using the modified lapse-rate-based barometric formula of Equation 11.

In some embodiments in which the selected reference plane is relatively far from the altitude of the mobile device 104, the term in the formula for the reference temperature measurement uncertainty σ_{T} in Equation 10 or 11 can be overly significant. (For example, the reference plane is 0 m HAE and the mobile device 104 is located at 1500 m HAE, corresponding to about a 15,000 Pa difference between device pressure and reference pressure, since 1 m vertical change is roughly 10 Pa of pressure change.) The “significance” of this term means that it erroneously or unduly amplifies the magnitude of the term for σ_{T}, leading to overestimations of altitude uncertainty. However, the reference plane can be chosen to be a different plane entirely without affecting the quality of the measurement, thereby mitigating or eliminating the “significance” of this term. For example, the reference plane can be chosen to be the same plane as that of the reference weather station 106, instead of 0 m HAE, so that the reference pressure P_{reference} will simply be the pressure measured by the reference barometric pressure sensor 130 of the reference weather station 106. In this case, the reference temperature measurement uncertainty σ_{T} would be unduly amplified only if the mobile device 104 is high above or far below the reference weather station 106. Additionally, the reference temperature measurement uncertainty σ_{T} can be set to zero if the mobile device 104 lies, or is assumed to lie, close to the reference plane or location; and, thus, the formula can be further reduced, e.g., the σ_{T} term in the formula is eliminated.

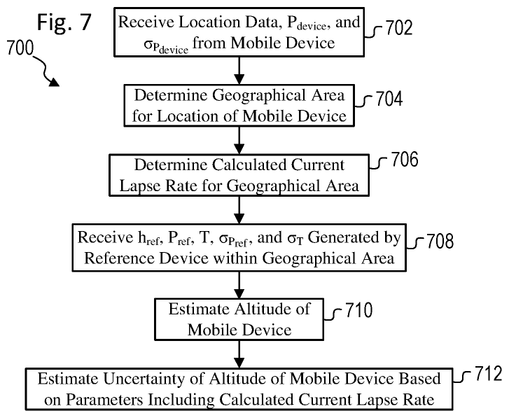

FIG. 7 shows a simplified flowchart for an example process 700 for estimating the altitude uncertainty using the calculated current lapse rate L, in accordance with some embodiments. The particular steps, combination of steps, and order of the steps for the process 700 are provided for illustrative purposes only. Other processes with different steps, combinations of steps, or orders of steps can also be used to achieve the same or similar result. Features or functions described for one of the steps performed by one of the components may be enabled in a different step or component in some embodiments. Additionally, some steps may be performed before, after or overlapping other steps, in spite of the illustrated order of the steps. Furthermore, although the example process 700 is described as being performed by the server 102, it is understood that in some embodiments some or all of the steps of the process 700 can be performed by the mobile device 104, instead, when the mobile device 104 generates or receives the necessary data.

At 702, the server 102 receives the location data, the device pressure P_{device}, and the device pressure uncertainty σ_{P}_{_{device}} from the mobile device 104. At 704, the server 102 estimates the location of the mobile device 104 based on the received location data and determines the geographical area 116 that includes the location of the mobile device 104.

At 706, the server 102 determines the calculated current lapse rate L for the geographical area 116, e.g., according to the example process 400 described above. In some embodiments, determining the calculated current lapse rate L at 706 involves receiving an already-stored calculated current lapse rate L for the geographical area 116 that encompasses the location of the mobile device 104.

At 708, the server 102 receives the reference altitude h_{ref}, the reference pressure P_{ref}, the reference temperature T, the reference pressure uncertainty σ_{P}_{_{ref}}, and the reference temperature uncertainty σ_{T} for the reference plane or location or as generated by the sensors of the reference weather station 106 (i.e., the reference device) that is nearest to the location of the mobile device 104 within the geographical area 116. At 710, the server 102 estimates the altitude of the mobile device 104 using either the full lapse-rate-based barometric formula of Equation 5 (based on the reference altitude h_{ref}, the reference pressure P_{ref}, the reference temperature T, the device pressure P_{device}, and the calculated current lapse rate L) or the simplified barometric formula of Equation 6 (based on the reference altitude h_{ref}, the reference pressure P_{ref}, the reference temperature T, and the device pressure P_{device}). At 712, the server 102 estimates the uncertainty of the altitude of the mobile device 104 based on parameters that include the reference pressure P_{ref}, the reference temperature T, the reference pressure uncertainty σ_{P}_{_{ref}}, the reference temperature uncertainty σ_{T}, the device pressure P_{device}, the device pressure uncertainty σ_{P}_{_{device}}, the calculated current lapse rate L using Equation 11, and the fit terms A-E.

In some embodiments, before determining the calculated current lapse rate L at 706, the server 102 receives the reference altitude h_{ref} for the reference plane or location or for the reference weather station 106 (i.e., the reference device), determines the estimated altitude of the mobile device 104, and then determines whether a difference between the estimated altitude of the mobile device 104 and the reference altitude for the reference plane or location or the reference weather station 106 is greater than a threshold distance (e.g., about 100 m). Therefore, when the difference between the estimated altitude of the mobile device 104 and the reference altitude for the reference plane or location or the reference weather station 106 is greater than the threshold distance, the server 102 uses the calculated current lapse rate in the estimating of the uncertainty of the altitude of the mobile device 104 by applying the full lapse-rate-based barometric formula of Equation 5 at 712. On the other hand, when the difference between the estimated altitude of the mobile device 104 and the reference altitude for the reference plane or location or the reference weather station 106 is not greater than the threshold distance, the server 102 does not determine the calculated current lapse rate L at 706, and the server 102 estimates the uncertainty of the altitude of the mobile device 104 without using the calculated current lapse rate L by applying the simplified lapse-rate-free barometric formula of Equation 6 in place of the estimation at 712. In this case, the calculation is processed faster due to being less computationally intensive for this option, since the calculated current lapse rate L is not determined or used. However, in this situation, a calculated current lapse rate L value of zero could be used in the full lapse-rate-based barometric formula of Equation 5, and the result would be equivalent to that of the simplified lapse-rate-free barometric formula of Equation 6.

The approach described herein is an improvement over conventional techniques, because it incorporates sensitivity for all variables in the full lapse-rate-based barometric formula (i.e., reference pressure, device pressure, and reference temperature). This formula would be useful in computation of altitude confidence for a mobile device 104 in a wide range of environments characterized by different temperature lapse rates and the mobile device 104 situated near ground, near rooftop sites, or far above the ground.

Any method, technique, process, approach or computation described or otherwise enabled by disclosure herein may be implemented by hardware components (e.g., machines), software modules (e.g., stored in machine-readable media), or a combination thereof. In particular, any method or technique described or otherwise enabled by disclosure herein may be implemented by any concrete and tangible system described herein. By way of example, machines may include one or more computing device(s), processor(s), controller(s), integrated circuit(s), chip(s), system(s) on a chip, server(s), programmable logic device(s), field programmable gate array(s), electronic device(s), special purpose circuitry, and/or other suitable device(s) described herein or otherwise known in the art. One or more non-transitory machine-readable media embodying program instructions that, when executed by one or more machines, cause the one or more machines to perform or implement computer-executable instructions or operations comprising the steps of any of the methods described herein are contemplated herein. As used herein, machine-readable media includes all forms of machine-readable media, including but not limited to one or more non-volatile or volatile storage media, removable or non-removable media, integrated circuit media, magnetic storage media, optical storage media, or any other storage media, including RAM, ROM, and EEPROM, that may be patented under the laws of the jurisdiction in which this application is filed, but does not include machine-readable media that cannot be patented under the laws of the jurisdiction in which this application is filed (e.g., transitory propagating signals). Methods disclosed herein provide sets of rules that are performed. Systems that include one or more machines and one or more non-transitory machine-readable media for implementing any method described herein are also contemplated herein. One or more machines that perform or implement, or are configured, operable or adapted to perform or implement operations comprising the steps of any methods described herein are also contemplated herein. Each method described herein that is not prior art represents a specific set of rules in a process flow that provides significant advantages in the fields of calibration and position location. Method steps described herein may be order independent and can be performed in parallel or in an order different from that described if possible to do so. Different method steps described herein can be combined to form any number of methods, as would be understood by one of ordinary skill in the art. Any method step or feature disclosed herein may be omitted from a claim for any reason. Certain well-known structures and devices are not shown in figures to avoid obscuring the concepts of the present disclosure. When two things are “coupled to” each other, those two things may be directly connected together, or separated by one or more intervening things. Where no lines or intervening things connect two particular things, coupling of those things is contemplated in at least one embodiment unless otherwise stated. Where an output of one thing and an input of another thing are coupled to each other, information sent from the output is received in its outputted form or a modified version thereof by the input even if the information passes through one or more intermediate things. Any known communication pathways and protocols may be used to transmit information (e.g., data, commands, signals, bits, symbols, chips, and the like) disclosed herein unless otherwise stated. The words comprise, comprising, include, including and the like are to be construed in an inclusive sense (i.e., not limited to) as opposed to an exclusive sense (i.e., consisting only of). Words using the singular or plural number also include the plural or singular number, respectively, unless otherwise stated. The word “or” and the word “and” as used in the Detailed Description cover any of the items and all of the items in a list unless otherwise stated. The words some, any and at least one refer to one or more. The terms may or can are used herein to indicate an example, not a requirement—e.g., a thing that may or can perform an operation, or may or can have a characteristic, need not perform that operation or have that characteristic in each embodiment, but that thing performs that operation or has that characteristic in at least one embodiment. Unless an alternative approach is described, access to data from a source of data may be achieved using known techniques (e.g., requesting component requests the data from the source via a query or other known approach, the source searches for and locates the data, and the source collects and transmits the data to the requesting component, or other known techniques).

An environment in which processes described herein may operate may include a network of weather stations (including terrestrial transmitters), at least one mobile device (e.g., user device), and at least one server. Each of the weather stations and the mobile device may be located at different altitudes or depths that are inside or outside various natural or manmade structures (e.g., buildings). Location or positioning signals may be respectively transmitted from the weather stations and satellites, and subsequently received by the mobile device using known transmission technologies. For example, the weather stations may transmit the signals using one or more common multiplexing parameters that utilize time slots, pseudorandom sequences, frequency offsets, or other approaches, as is known in the art or otherwise disclosed herein. The mobile device may take different forms, including a mobile phone or other wireless communication device, a portable computer, a navigation device, a tracking device, a receiver, or another suitable device that can receive the signals. Each weather station and mobile device may include atmospheric sensors (e.g., a pressure and temperature sensors) for generating measurements of atmospheric conditions (e.g., pressure and temperature) that are used to estimate an unknown altitude of the mobile device. By way of example, a pressure sensor of the mobile device may also be calibrated from time to time.

By way of example in FIG. 8, weather stations 106 discussed herein may include: a mobile device interface 11 for exchanging information with the mobile device 104 (e.g., antenna(s) and RF front end components known in the art or otherwise disclosed herein); one or more processor(s) 12; memory/data source 13 for providing storage and retrieval of information and/or program instructions; atmospheric sensor(s) 14 for measuring environmental conditions (e.g., pressure, temperature, humidity, other) at or near the weather station 106; a server interface 15 for exchanging information with the server 102 (e.g., an antenna, a network interface, or other); and any other components known to one of ordinary skill in the art. The memory/data source 13 may include memory storing software modules with executable instructions, and the processor(s) 12 may perform different actions by executing the computer-executable instructions from the modules, including: (i) performance of part or all of the methods as described herein or otherwise understood by one of skill in the art as being performable at the weather station 106; (ii) generation of positioning signals for transmission using a selected time, frequency, code, and/or phase; (iii) processing of signaling received from the mobile device 104 or other source; or (iv) other processing as required by operations described in this disclosure. Signals generated and transmitted by the weather station 106 may carry different information that, once determined by the mobile device 104 or the server 102, may identify the following: the weather station 106; the weather station's position; environmental/weather conditions at or near the weather station 106; and/or other information known in the art. The atmospheric sensor(s) 14 may be integral with the weather station 106, or separate from the weather station 106 and either co-located with the weather station 106 or located in the vicinity of the weather station 106 (e.g., within a threshold amount of distance).

By way of example in FIG. 8, the mobile device 104 may include a weather station interface 21 for exchanging information with the weather station(s) 106 (e.g., antenna(s) and RF front end components known in the art or otherwise disclosed herein); one or more processor(s) 22; memory/data source 23 for providing storage and retrieval of information and/or program instructions; atmospheric sensor(s) 24 (including the barometric pressure sensor 126) for measuring environmental conditions (e.g., pressure, temperature, other) at the mobile device 104; other sensor(s) 25 for measuring other conditions (e.g., compass, accelerometer and inertial sensors for measuring movement and orientation); a user interface 26 (e.g., display, keyboard, microphone, speaker, other) for permitting the user of the mobile device 104 to provide inputs and receive outputs; a network interface 27 for exchanging information with the server 102 via the communication pathway of the communication systems 108 (e.g., a wired and/or a wireless interface port, an antenna and RF front end components known in the art or otherwise disclosed herein); and any other components known to one of ordinary skill in the art. A GNSS interface and processing unit (not shown) are contemplated, which may be integrated with other components or a standalone antenna, RF front end, and processors dedicated to receiving and processing GNSS signaling. The memory/data source 23 may include memory storing data and software modules with executable instructions, including a signal processing module, a signal-based position estimate module, a pressure-based altitude module, a lapse-rate-based altitude uncertainty module, a location determination module, the current calibration value, the data packet, a calibration module, and other modules. The processor(s) 22 may perform different actions by executing the computer-executable instructions from the modules, including: (i) performance of part or all of the methods, processes and techniques as described herein or otherwise understood by one of ordinary skill in the art as being performable at the mobile device 104; (ii) estimation of the altitude of the mobile device 104 (based on measurements of pressure from the mobile device 104 and the weather station(s) 106, temperature measurement(s) from the weather station(s) 106 or another source, and any other information needed for the computation); (iii) estimation of the altitude uncertainty of the mobile device 104 (based on measurements of pressure from the mobile device 104 and the weather station(s) 106, temperature measurement(s) from the weather station(s) 106 or another source, uncertainty data, and any other information needed for the computation); (iv) processing of received signals to determine position information or location data (e.g., times of arrival or travel time of the signals, pseudoranges between the mobile device 104 and the weather stations 106, weather station atmospheric conditions, locations or other weather station information); (v) use of position information to compute an estimated position of the mobile device 104; (vi) determination of movement based on measurements from inertial sensors of the mobile device 104; (vii) GNSS signal processing; (viii) storing the current calibration value 128; (ix) calibrating the barometric pressure sensor 126; and/or (x) other processing as required by operations described in this disclosure.

By way of example in FIG. 8, the server 102 may include: a network interface 31 for exchanging information with the mobile device 104 and other sources of data via the communication pathway of the communication systems 108 (e.g., a wired and/or a wireless interface port, an antenna, or other); one or more processor(s) 32; memory/data source 33 or providing storage and retrieval of information and/or program instructions; a weather station interface 34 for exchanging information with the weather station(s) 106 (e.g., antenna(s) and RF front end components known in the art or otherwise disclosed herein); and any other components known to one of ordinary skill in the art. The memory/data source 33 may include memory storing software modules with executable instructions, such as calibration technique modules, a signal-based positioning module, a pressure-based altitude module, a lapse-rate-based altitude uncertainty module, a calibration conduciveness module, as well as other modules for each of the above described methods and processes or portions/steps thereof. The processor(s) 32 may perform different actions by executing computer-executable instructions from the modules, including: (i) performance of part or all of the methods, processes and techniques as described herein or otherwise understood by one of ordinary skill in the art as being performable at the server 102; (ii) estimation of an altitude of the mobile device 104; (iii) estimation of the altitude uncertainty of the mobile device 104 (based on measurements of pressure from the mobile device 104 and the weather station(s) 106, temperature measurement(s) from the weather station(s) 106 or another source, uncertainty data, and any other information needed for the computation); (iv) computation of an estimated position of the mobile device 104; (v) performance of calibration techniques; (vi) calibration of the mobile device 104; or (vii) other processing as required by operations or processes described in this disclosure. Steps performed by servers 102 as described herein may also be performed on other machines that are remote from the mobile device 104, including computers of enterprises or any other suitable machine.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

1. A method comprising:
estimating, by a server, a location of a mobile device;
receiving, by the server, a device pressure from the mobile device;
determining, by the server, a calculated current lapse rate for a geographical area that includes the location of the mobile device, the calculated current lapse rate providing an estimated air temperature variation with respect to altitude variation for the location of the mobile device;
receiving, by the server, a reference pressure and a reference temperature for a reference plane that is within the geographical area;
estimating, by the server, an altitude of the mobile device; and
estimating, by the server, an uncertainty of the altitude of the mobile device based on the reference pressure, the reference temperature, the device pressure, and the calculated current lapse rate.

2. The method of claim 1, wherein:
the estimating of the uncertainty of the altitude of the mobile device is further based on an uncertainty of the reference temperature, an uncertainty of the reference pressure, and an uncertainty of the device pressure.

3. The method of claim 1, further comprising:
updating the calculated current lapse rate a plurality of times per day.

4. The method of claim 1, wherein:
the determining of the calculated current lapse rate further comprises estimating the calculated current lapse rate when the server determines that the altitude of the mobile device and the uncertainty of the altitude are to be estimated.

5. The method of claim 1, wherein the determining of the calculated current lapse rate further comprises:
receiving a plurality of temperature measurements and a plurality of sensor altitudes for a respective plurality of sensors that are within the geographical area;
for each pair of sensors of the plurality of sensors that are not at about a same altitude, determining a temperature difference between the temperature measurements therefor with respect to an altitude difference between the sensor altitudes therefor to obtain a plurality of temperature-difference to altitude-difference ratios;
determining a mean of the plurality of temperature-difference to altitude-difference ratios; and
using the mean of the plurality of temperature-difference to altitude-difference ratios as the calculated current lapse rate for the geographical area.

6. The method of claim 1, wherein the determining of the calculated current lapse rate further comprises:
receiving a plurality of temperature measurements and a plurality of sensor altitudes for a respective plurality of sensors that are within the geographical area;
for each pair of sensors of the plurality of sensors that are not at about a same altitude, determining a temperature difference between the temperature measurements therefor with respect to an altitude difference between the sensor altitudes therefor to obtain a plurality of temperature-difference to altitude-difference ratios;
determining a grid of lapse rate data based on the plurality of temperature-difference to altitude-difference ratios; and
interpolating the calculated current lapse rate from the grid of lapse rate data.

7. The method of claim 1, further comprising:
receiving, by the server, a reference altitude for the reference plane;
determining, by the server, whether a difference between the estimated altitude of the mobile device and the reference altitude for the reference plane is greater than a threshold distance;
when the difference between the estimated altitude of the mobile device and the reference altitude for the reference plane is greater than the threshold distance, using the calculated current lapse rate in the estimating of the uncertainty of the altitude of the mobile device; and
when the difference between the estimated altitude of the mobile device and the reference altitude for the reference plane is not greater than the threshold distance, the server not determining the calculated current lapse rate, and the server estimating the uncertainty of the altitude of the mobile device without using the calculated current lapse rate.

8. The method of claim 1, further comprising:
receiving, by the server, a reference altitude for the reference plane;
wherein the estimated altitude of the mobile device is based on the reference altitude, the reference pressure, the reference temperature, the device pressure, and the calculated current lapse rate.

9. One or more non-transitory machine-readable media embodying program instructions that, when executed by one or more machines, cause the one or more machines to implement the method of claim 1.

10. A system comprising: memory comprising computer-executable instructions; and a machine configured to execute the computer-executable instructions and cause the system to perform the method of claim 1.

11. A method comprising:
estimating, by a mobile device, a location of the mobile device;
generating, by the mobile device, a device pressure for the mobile device;
sending, by the mobile device to a server, the location of the mobile device;
receiving, by the mobile device from the server, a calculated current lapse rate for a geographical area that includes the location of the mobile device, the calculated current lapse rate providing an estimated air temperature variation with respect to altitude variation for the location of the mobile device;
receiving, by the mobile device, a reference pressure and a reference temperature generated for a reference plane that is within the geographical area;
estimating, by the mobile device, an altitude of the mobile device; and
estimating, by the mobile device, an uncertainty of the altitude of the mobile device based on the reference pressure, the reference temperature, the device pressure, and the calculated current lapse rate.

12. The method of claim 11, wherein:
the estimating of the uncertainty of the altitude of the mobile device is further based on an uncertainty of the reference temperature, an uncertainty of the reference pressure, and an uncertainty of the device pressure.

13. The method of claim 11, wherein:
the server updates the calculated current lapse rate a plurality of times per day and sends a most recently calculated current lapse rate as the calculated current lapse rate to the mobile device.

14. The method of claim 11, wherein:
the mobile device sends the location of the mobile device to the server when the mobile device determines that the altitude of the mobile device and the uncertainty of the altitude are to be estimated; and
the server estimates the calculated current lapse rate when the server receives the location of the mobile device.

15. The method of claim 11, further comprising:
receiving, by the server from the mobile device, the location of the mobile device;
determining, by the server, the geographical area that includes the location of the mobile device;
receiving, by the server, a plurality of temperature measurements and a plurality of sensor altitudes for a respective plurality of sensors that are within the geographical area;
for each pair of sensors of the plurality of sensors that are not at about a same altitude, determining, by the server, a temperature difference between the temperature measurements therefor with respect to an altitude difference between the sensor altitudes therefor to obtain a plurality of temperature-difference to altitude-difference ratios;
determining, by the server, a mean of the plurality of temperature-difference to altitude-difference ratios as the calculated current lapse rate for the geographical area; and
sending, by the server to the mobile device, the calculated current lapse rate.

16. The method of claim 11, further comprising:
receiving, by the server from the mobile device, the location of the mobile device;
determining, by the server, the geographical area that includes the location of the mobile device;
receiving, by the server, a plurality of temperature measurements and a plurality of sensor altitudes for a respective plurality of sensors that are within the geographical area;
for each pair of sensors of the plurality of sensors that are not at about a same altitude, determining, by the server, a temperature difference between the temperature measurements therefor with respect to an altitude difference between the sensor altitudes therefor to obtain a plurality of temperature-difference to altitude-difference ratios;
determining, by the server, a grid of lapse rate data based on the plurality of temperature-difference to altitude-difference ratios;
interpolating, by the server, the calculated current lapse rate from the grid of lapse rate data; and
sending, by the server to the mobile device, the calculated current lapse rate.

17. The method of claim 11, further comprising:
receiving, by the mobile device, a reference altitude for the reference plane;
determining, by the mobile device, whether a difference between the estimated altitude of the mobile device and the reference altitude for the reference plane is greater than a threshold distance;
when the difference between the estimated altitude of the mobile device and the reference altitude for the reference plane is greater than the threshold distance, using, by the mobile device, the calculated current lapse rate in the estimating of the uncertainty of the altitude of the mobile device; and
when the difference between the estimated altitude of the mobile device and the reference altitude for the reference plane is not greater than the threshold distance, the mobile device not receiving the calculated current lapse rate, and the mobile device estimating the uncertainty of the altitude of the mobile device without using the calculated current lapse rate.

18. The method of claim 11, further comprising:
receiving, by the mobile device, a reference altitude for the reference plane;
wherein the estimated altitude of the mobile device is based on the reference altitude, the reference pressure, the reference temperature, the device pressure, and the calculated current lapse rate.
